(19) United States
(12) Patent Application Publication
(10) Pub. No.: US 2016/0267433 A1
(43) Pub. Date: Sep. 15, 2016

(54) METHODS, DEVICES, AND SYSTEMS FOR GENERATING AND VERIFYING A DOCUMENT

(71) Applicant: Tencent Technology (Shenzhen) Company Limited, Shenzhen (CN)

(72) Inventor: Wei LIU, Shenzhen (CN)

(73) Assignee: Tencent Technology (Shenzhen) Company Limited, Shenzhen (CN)

(21) Appl. No.: 15/159,367

(22) Filed: May 19, 2016

Related U.S. Application Data
(63) Continuation of application No. PCT/CN2014/088215, filed on Oct. 9, 2014.

(30) Foreign Application Priority Data
Dec. 31, 2013 (CN) 201310750402.9

(51) Int. Cl. G06Q 10/10; H04L 9/32

(52) U.S. Cl. CPC G06Q 10/10; H04L 9/3247; G06Q 2220/16

(57) ABSTRACT

A terminal implementing a method for generating a two-dimensional code may be configured to obtain original document information comprised in an original document information; generate a first summary report based on the original document information; encrypt the first summary report into a digital signature of the original document information; and generate a two-dimensional code based on the original document information and the digital signature. A terminal implementing a method for verifying a document may be configured to obtain a two-dimensional code encrypted from an original document that comprises original document information and a digital signature comprising a first summary report corresponding to the original document information; retrieve from the two-dimensional code the original document information and the digital signature; verify the two-dimensional code according to the original document information and the digital signature; and determine the two-dimensional code to be authentic when the verification is successful.

### PRIORITY STATEMENT

This application is a continuation of International Application No. PCT/CN2014/088215, filed on Oct. 9, 2014, in the State Intellectual Property Office of the People's Republic of China, which claims the priority benefit of Chinese Patent Application No. 201310750402.9 filed on Dec. 31, 2013, the disclosures of which are incorporated herein in their entirety by reference.

### FIELD

The present disclosure relates to electronic information technology. Specifically, the present disclosure relates to methods, devices, and systems for generating documents, a method of verifying documents.

### BACKGROUND

As the society develops, commodity transaction has become an everyday action of some customers. When a customer carries out the commodity transaction, commonly the seller provides him with supporting documents (e.g., an invoice). With the supporting documents, the customer could request from the seller corresponding services in a later time.

The conventional supporting documents include receipt documents, payment documents, transfer documents, delivery receipts, goods-pick-up documents, goods-transfer documents, etc. As an example of a goods-pick-up document, when a customer buys certain products from a seller with a certain quantity online and selects to pick up the products locally, the seller provides a goods-pick-up document after the customer pays online. The goods-pick-up document generally includes information such as names of the products, amount of the products, value of the transaction, transaction date, name of the seller, address of the seller, or date of picking up the products etc. When the customer wishes to fetch the goods, he/she must present the goods-pick-up document to the seller. The customer can pick up the goods only after the seller verifies the goods-pick-up document.

However, since the supporting documents provided by the seller are traditionally paper documents, contents on the supporting documents are easy to be changed, or the supporting documents are easily forged. As a result, it is difficult for the seller to verify the authenticity of a supporting document.

### SUMMARY

According to an aspect of the present disclosure, a verifying terminal may comprise a processor-readable storage medium comprising a set of instructions for verifying a document by the verifying terminal; and a processor in communication with the storage medium. The processor is configured to execute the set of instructions to obtain a two-dimensional code encrypted from an original document that comprises original document information and a digital signature comprising a first summary report corresponding to the original document information; retrieve from the two-dimensional code the original document information and the digital signature; verify the two-dimensional code according to the original document information and the digital signature; and determine the two-dimensional code to be authentic when the verification is successful.

According to another aspect of the present disclosure, a method for verifying a document by a verifying terminal may comprise obtaining a two-dimensional code encrypted from an original document that comprises original document information and a digital signature comprising a first summary report corresponding to the original document information; retrieving from the two-dimensional code the original document information and the digital signature; verifying the two-dimensional code according to the original document information and the digital signature; and determining the two-dimensional code to be authentic when the verification is successful.

According to another aspect of the present disclosure, a terminal may comprise a processor-readable storage medium comprising a set of instructions for generating a two-dimensional code by the terminal; and a processor in communication with the storage medium. The processor may be configured to execute the set of instructions to obtain original document information comprised in an original document information; generate a first summary report based on the original document information; encrypt the first summary report into a digital signature of the original document information; and generate a two-dimensional code based on the original document information and the digital signature.

According to yet another aspect of the present disclosure, a method for generating a two-dimensional code by a terminal may comprise obtaining original document information comprised in an original document information; generating a first summary report based on the original document information; encrypting the first summary report into a digital signature of the original document information; and generating a two-dimensional code based on the original document information and the digital signature.

### BRIEF DESCRIPTION OF THE DRAWINGS

The above and other features and advantages will become more apparent by describing in detail example embodiments thereof with reference to the attached drawings in which:

FIG. 1 is a flowchart of a method of verifying documents according to an example embodiment of the present disclosure;

FIG. 2 is a flowchart of a method of generating a two-dimensional code documents according to an example embodiment of the present disclosure;

FIG. 3 is a flowchart of a method of verifying documents according to another example embodiment of the present disclosure;

FIG. 4 is a block diagram of a device of verifying documents according to an example embodiment of the present disclosure;

FIG. 5A is a block diagram of a device of verifying documents according to another example embodiment of the present disclosure;

FIG. 5B is a block diagram of a signature verification unit according to an example embodiment of the present disclosure;

FIG. 6 is a block diagram of a device of generating documents according to an example embodiment of the present disclosure;

FIG. 7 is a block diagram of a device of generating documents according to another example embodiment of the present disclosure; and

FIG. 8 is a schematic diagram illustrating an example embodiment of a terminal.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

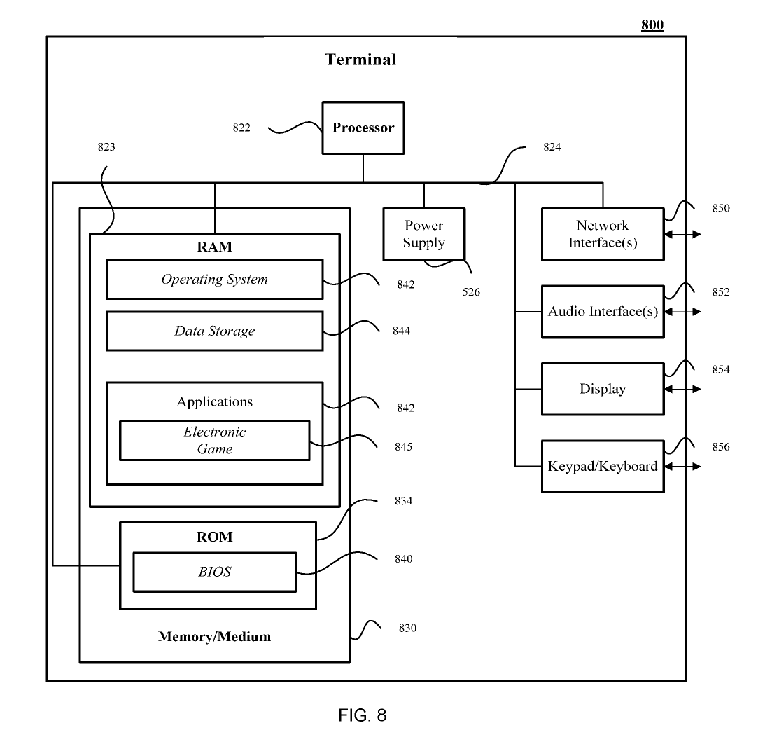

FIG. 8 is a schematic diagram illustrating an example embodiment of a terminal 800. The terminal 800 may include apparatuses to execute methods and/or software systems introduced in the present disclosure. The terminal 800 may be a computing device capable of executing a software system. The terminal 800 may, for example, be a device such as a personal desktop computer or a portable device, such as a laptop computer, a tablet computer, a cellular telephone, or a smart phone.

The terminal 800 may vary in terms of capabilities or features. Claimed subject matter is intended to cover a wide range of potential variations. For example, the terminal 800 may include a keypad/keyboard 856. It may also include a display 854, such as a liquid crystal display (LCD), or a display with a high degree of functionality, such as a touch-sensitive color 2D or 3D display. In contrast, however, as another example, a web-enabled terminal 800 may include one or more physical or virtual keyboards, and mass storage medium 830.

The terminal 800 may also include or may execute a variety of operating systems 841, including an operating system, such as a Windows™ or Linux™, or a mobile operating system, such as iOS™, Android™, or Windows Mobile™. The terminal 800 may include or may execute a variety of possible applications 842, such as an electronic game 845. An application 842 may enable communication with other devices via a network, such as communicating with another computer or content server via a network.

Further, the terminal 800 may include one or more non-transitory processor-readable storage media 830 and one or more processors 822 in communication with the non-transitory processor-readable storage media 830. For example, the non-transitory processor-readable storage media 830 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 830 may store sets of instructions, or units and/or modules that include the sets of instructions, for conducting operations and/or method steps described in the present disclosure. Alternatively, the units and/or modules may be hardware disposed in the terminal 800 configured to conduct operations and/or method steps described in the present disclosure. The one or more processors may be configured to execute the sets of instructions and perform the methods and/or operations in example embodiments of the present disclosure.

Merely for illustration, only one processor will be described in terminals that execute operations and/or method steps in the following example embodiments. However, it should be note that the terminals in the present disclosure may also include multiple processors, thus operations and/or method steps that are performed by one processor as described in the present disclosure may also be jointly or separately performed by the multiple processors. For example, if in the present disclosure a processor of a terminal executes both step A and step B, it should be understood that step A and step B may also be performed by two different processors jointly or separately in the terminal (e.g., the first processor executes step A and the second processor executes step B, or the first and second processors jointly execute steps A and B).

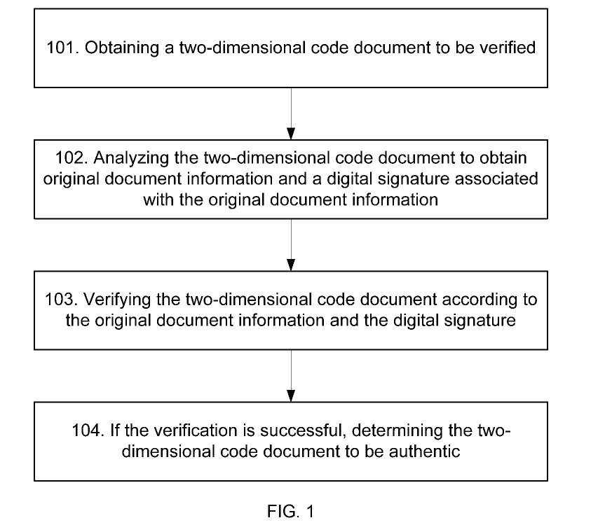

FIG. 1 is a flowchart of a method for verifying document according to an example embodiment of the present disclosure. The method may be implemented in and executed by a document verification terminal, such as the terminal 800. The method may include the following steps:

Step 101, obtaining a two-dimensional code document to be verified; wherein the two-dimensional code may be a two-dimensional bar code and the two-dimensional code document may be a document with the two-dimensional bar code.

Step 102, analyzing the two-dimensional code document to obtain original document information and a digital signature associated with the original document information; wherein the digital signature is configured to verify authenticity of the two-dimensional code document.

Step 103, verifying the two-dimensional code document according to the original document information and the digital signature;

Step 104, if the verification is successful, determining the two-dimensional code document to be authentic.

Accordingly to the method of verifying documents of the present disclosure, the document verification terminal 800 may obtain a two-dimensional code document to be verified, then analyze the two-dimensional code document to get an original document information and a digital signature associated with the original document information, and then verify the two-dimensional code document according to the original document information and the digital signature. If the verification is successful, the original document is determined to be authentic. Since both the original document information and the digital signature are included in the two-dimensional code document, it is convenient and accurate for the seller to verify the document by verifying the digital signature, which reduces difficulty of verification. Furthermore, the digital signature may not be easily forged and fabricated, thus the forgery issue may be effectively prevented. In addition, adopting the two-dimensional code documents also reduces the usage of papery documents, which may be lost easily.

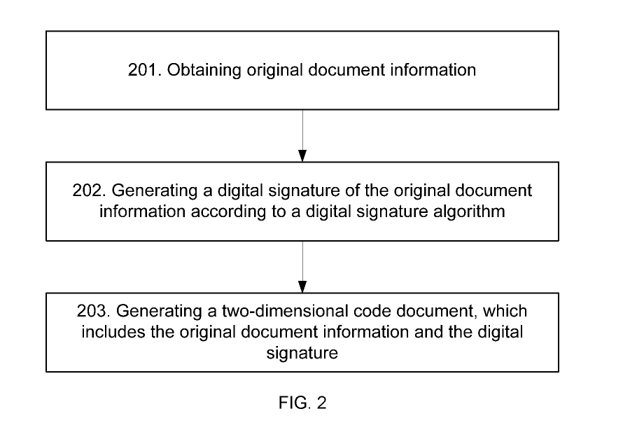

FIG. 2 is a flowchart of a method for generating a two-dimensional code document according to an example embodiment of the present disclosure. The method may be implemented in and executed by a two-dimensional code document generating terminal, such as the terminal 800. The method may include the following steps:

Step 201, obtaining original document information;

Step 202, generating a digital signature of the original document information according to a digital signature algorithm;

Step 203, generating a two-dimensional code document, which includes the original document information and the digital signature. The digital signature is configured to verify authenticity of the two-dimensional code document.

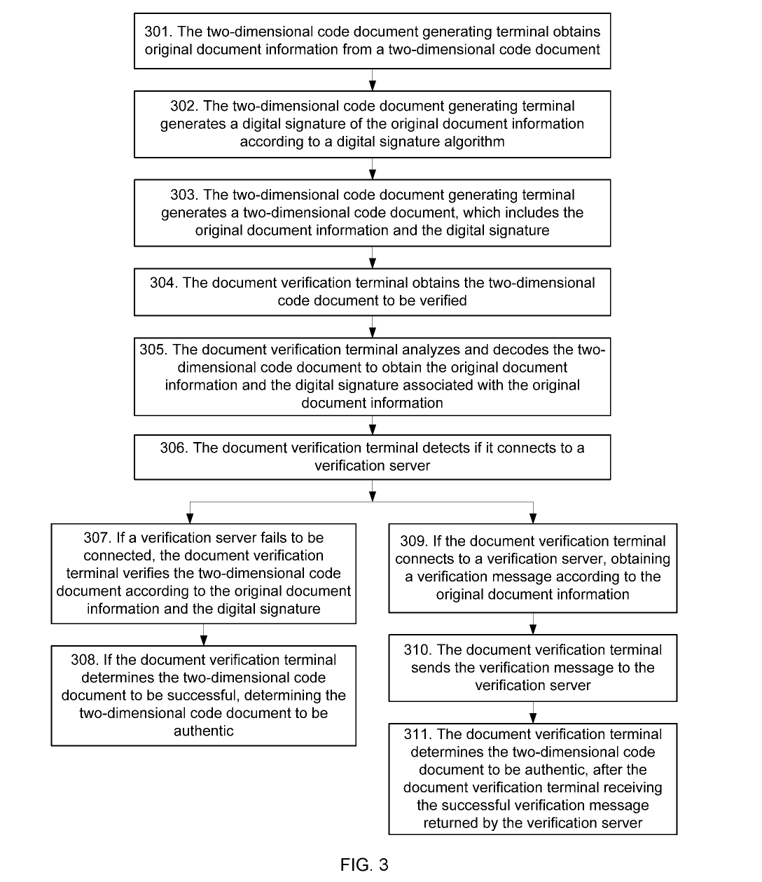

Accordingly to the method of generating documents of the present disclosure, the two-dimensional code document generating terminal 800 may to obtain original document information, and then generate a digital signature of the original document information, and finally generates a two-dimensional code document with the original document information and the digital signature. Because the digital signature is hard to be forged and fabricated, the risk of forgery is reduced. Furthermore, since both the original document information and the digital signature are included in the two-dimensional code document, thus it is convenient and accurate for the seller to verify the document by verifying the digital signature, which reduces difficulty of verification. In addition, adopting the two-dimensional code documents also reduces the usage of paper documents which may be lost easily.
FIG. 3 shows a flowchart of a method of verifying documents according to another example embodiment of the present disclosure. The method may be implemented in and executed by a two-dimensional code document generating terminal, such as the terminal 800. The method may include the following steps:

Step 301, the two-dimensional code document generating terminal obtains original document information from a two-dimensional code document.

In this step, the two-dimensional code document generating terminal may have two ways for obtaining the original document information.

First, the two-dimensional code document generating terminal obtains document contents, and then takes the document contents as the original document information. The document contents may includes:

When the two-dimensional code document is a receipt document, the document content may include receipt date, receipt reason, payee information, payer information, and amount of money received.

When the two-dimensional code document is a payment document, the document content may include payment date, payment reason, payee information, payer information, and payment amount;

When the two-dimensional code document is a transfer document, the document content may include transfer date, transferor information, transferee information, transfer amount, and transfer organization information;

When the two-dimensional code document is a delivery receipt, the document content may include delivery date, name of goods, deliverer information, recipient information and amount of goods;

When the two-dimensional code document is a goods-pick-up document, the document content may include deadline picking up the goods, name of goods, recipient information and amount of goods;

When the two-dimensional code document is a goods-transfer document, the document content may include transfer date, transferor information, recipient information and amount of goods.

For example, a customer wishes to exchange a product, either by money or by a coupon, with a seller (e.g., by consuming at the seller's store for a certain number of times, the consumer may earn enough credits from the seller to exchange a bottle of ice tea), but because this product is currently out of stock the seller provides to the customer a two-dimensional code document as a proof that the customer has paid for this product, so that the customer could pick up this product in due course. Through the two-dimensional code document, the two-dimensional code document generating terminal could obtain the information such as name of the product, amount of the product, name of the seller, ID of the customer, and date, etc., which are regarded as the original document information by two-dimensional code document generating terminal. In actual practice, the two-dimensional code document generating terminal may obtain more information of the product, such as material of the product, name of the manufacturer, address of the manufacturer and telephone number of the manufacturer, which are not limited in the example embodiments of the present disclosure.

Second, the two-dimensional code document generating terminal obtains a link address of the document contents, and takes the link address as the original document information.

Because the document contents may be further stored in a certain web page, thus taking contents from the link address as the original document information may be another way to obtain the original document information. This method may be used together with the above method of retrieving information directly from the two-dimensional code document, or may be used as an alternative way to obtain the original document information.

It should be noted that, in example embodiments of the present disclosure, part of the original document information may be encoded in the two-dimensional code document and part of the original document information may be stored in the link address. The present disclosure does not intend to limit ways of dissembling and/or assembling the original document information.

Step 302, the two-dimensional code document generating terminal generates a digital signature of the original document information according to a digital signature algorithm. This step may include the following steps:

Firstly, the two-dimensional code document generating terminal generates a summary report of the original document information according a digital signature algorithm and the original document information.

In this step, the digital signature algorithm may include RSA algorithm and/or SSF33 algorithm. As an example of RSA algorithm, the two-dimensional code document generating terminal may input the original document information as a one-way function provided by the digital signature algorithm, and take the output of the one-way function as the summary report. For example, the one-way function is a function that an output can be calculated according to an input, but an input cannot be reverse-engineered from an output.

Secondly, the two-dimensional code document generating terminal encrypts the summary report to obtain the digital signature.

In this step, the two-dimensional code document generating terminal encrypts the summary report by using a private key which is assigned in advance, so as to obtain an encrypted signature. The encrypted signature is regarded as the digital signature.

In an off-line verification situation, i.e., when the document verification terminal needs to verify authenticity of the two-dimensional code document but the document verification terminal does not connect with a verification server, the original document information and the digital signature are used for instructing the document verification terminal to verify the digital signature according to the original document information. The two-dimensional code document is determined to be authentic if the verification of the digital signature is passed.

In an online verification situation, i.e., when the document verification terminal needs to verify authenticity of the two-dimensional code document, and the document verification terminal is connected with a verification server, the original document information is configured to instruct the verification server to find if here exists information that matches a verification message, wherein the verification message includes document contents carried in the original document information and/or a link address. If the verification server does find the matching information, the verification sever may send a confirmation and/or successful verification message to the document verification terminal and the two-dimensional code document is determined to be authentic.

Step 303, the two-dimensional code document generating terminal generates a two-dimensional code document, which includes the original document information and the digital signature.

In this step, the two-dimensional code document generating terminal may generate the two-dimensional code document incorporating the original document information and the digital signature associated with the original document information.

It should be noted that, the more information incorporated into the two-dimensional code, the more complicate the two-dimensional code is, and accordingly the lower accuracy in identifying and verifying the two-dimensional code. In order to retain a reasonably high identification and verification accuracy, the two-dimensional code document generating terminal may place contents (all or partial) of the document in a webpage and use the link address of the webpage as the original document information in generating the two-dimensional code. This may effectively reduce the information embedded in the two-dimensional code document, thereby improving the accuracy for identifying the two-dimensional code document.

It should be also noted that, after the two-dimensional code document is generated by the two-dimensional code document generating terminal, it may be offered to the customer. In this step, the two-dimensional code document generating terminal may send the two-dimensional code document to the customer's cellphone, and/or an instant messaging terminal of the customer. In comparison with the papery documents, this two-dimensional code document received by the customer in such a way will not be lost easily, which is convenient. In addition, the two-dimensional code document generating terminal may simultaneously generate a two-dimensional code document that includes the document contents and a corresponding digital signature and a two-dimensional code document that includes a link address of the document contents and a digital signature of the link address, and provide to the customer with both two-dimensional code documents.

Step 304, the document verification terminal obtains the two-dimensional code document to be verified.

When the customer wants to pick up the products from the seller, he will show the two-dimensional code document received by the cellphone or the instant messaging terminal. The seller may use the document verification terminal to scan the two-dimensional code, which will be scanned and obtained by the document verification terminal.

It should be noted that, if the two-dimensional code document generating terminal provides the customer with both of the two two-dimensional code documents, the customer may show one of them to the document verification terminal according to the actual demand. In this step, when the document contents are included in the original document information, the document verification terminal may or may not interact with a storage server to obtain the document contents; but when the link address is included in the original document information, the document verification terminal may interact with the storage server to obtain the document contents. Also, if the document verification terminal is off-line, the customer needs to present the two-dimensional code document with the document contents and the digital signature to the document verification terminal; if the document verification terminal is on-line, the customer may present any one of the two two-dimensional code documents to the document verification terminal.

Step 305, the document verification terminal analyzes and decodes the two-dimensional code document to obtain the original document information and the digital signature associated with the original document information.

When all information during the transaction between the customer and the seller are included in the original document information, the document verification terminal may obtain all the transaction information after analyzing the corresponding two-dimensional code document, thereby retroactively reviewed the transaction.

Step 306, the document verification terminal detects if it connects to a verification server.

After the document verification terminal analyzes and decodes the two-dimensional code document and obtains the original document information and the digital signature associated with the original document information, the document verification terminal may determine if it has established a connection to the verification server. The verification server is configured to verify a part of or the whole original document information.

Step 307, if a verification server fails to be connected, the document verification terminal verifies the two-dimensional code document according to the original document information and the digital signature.

To this end, the document verification terminal may conduct the following steps:

Firstly, verifying the digital signature according to the original document information.

a) Decrypting the digital signature to retrieve a summary report (hereinafter “the first summery report”) encoded therein.

As introduced above, the digital signature is a ciphertext signature encrypted by a private key, thus the document verification terminal need to decrypt the digital signature to retrieve the first summary report. Based on technologies such as public-key cryptography, each private key is corresponding to a public key, which may be used to decrypt a document encrypted by the private key. Accordingly, the document verification terminal may obtain the public key corresponding to the private key in advance and may decrypt the digital signature using the public key.

b) Generating a summary report (hereinafter “the second summary report”) corresponding to the original document information.

In this step, the document verification terminal may generate the second summary report corresponding to the original document. Because the one-way function used to generate the digital signature is public, the document verification terminal may obtain the summary report of the original document information according to the same one-way function with that used during the creation of the digital signature.

c) Determining if the first summary report matches the second summary report.

d) If yes, determining the verification of the digital signature to be successful.

If the first and second summary reports match each other, the digital signature is verified; if the first and second summary report do not match each other, the document verification terminal may determine that the contents of the original document information has been juggled, and this verification fails.

Secondly, if the verification of the digital signature is successful, determining the verification of the two-dimensional code document to be successful.

In this step, if the verification of the digital signature is successful, the verification of the two-dimensional code document is successful; if the verification of the digital signature fails, the verification of the two-dimensional code document fails as well.

Step 308, if the document verification terminal determines the two-dimensional code document to be successful, determining the two-dimensional code document to be authentic.

For example, if the two-dimensional code document presented by the customer is verified, the document verification terminal may determine that the two-dimensional code document is an authentic document produced by the seller.

After that, the document verification terminal may provide and/or display information showing that the two-dimensional code document is an authentic document, such as display a message, a video, or an audio to show that the verification is successful. Accordingly, the seller may provide the service and/or products of the transaction with the customer according to the two-dimensional code document.

If the verification of the two-dimensional code document fails, the document verification terminal may determine the two-dimensional code document is not an authentic document. The seller may refuse to provide the product and/or service described in the two-dimensional code document.

Step 309, if the document verification terminal connects to a verification server, obtaining a verification message according to the original document information.

The verification message includes document contents carried in the original document information and/or a link address.

In this step, the step of obtaining the verification message may include:

First, if the document contents are included in the original document information, taking the document contents as the verification message;

Second, if the link address of the document contents is included in the original document information, taking the link address as the verification message; or, sending a request for obtaining the document content to a storage server according to the link address, then receiving the document contents returned by the storage server, and taking the former or both of the document contents and the link address as the verification message.

If the link address of the document contents is included in the original document information, the link address can be taken as the verification message directly. Of course, the document contents may be obtained according to the link address. Thus in actual practice, the document verification terminal may further send a request for obtaining the document contents to the storage server, and then the storage server returns the requested document contents to the document verification terminal. Accordingly, the document contents received by the document verification terminal will be taken as a verification message or the combination of the document contents and the link address will be taken as a verification message. And the obtaining way of the verification message is not limited in the embodiments.

Step 310, the document verification terminal sends the verification message to the verification server to determine if information matching with verification message exists, if yes, then the verification server returns a successful verification message.

After the verification message is received by the document verification terminal, it will be sent to the verification server accordingly. And then, the verification server will detect if information matching with the verification message is existed, if yes, then it is ensured that the information in the original document was registered by the seller. At this time, a successful verification message may be returned by the verification server; otherwise, a failed verification message may be returned.

Step 311, the document verification terminal determines the two-dimensional code document to be authentic, after the document verification terminal receiving the successful verification message returned by the verification server.

After determining the two-dimensional code document to be authentic, the seller may supply services and/or goods to the customer according to the two-dimensional code document, to finish the transaction.

If a failed verification message is returned, then this document is determined to be unauthentic, thus the seller will refuse to offer any service and/or goods, which is not explained in detail here.

It should be noted that, when the document verification terminal is connected with the verification server, the document verification terminal may firstly verify the digital signature, and sent a verification message to the verification server after the verification of the digital signature is succeeded. After receiving a successful verification message returned by the verification server, the document verification terminal could determine the two-dimensional code document to be authentic. Alternatively, the document verification terminal may send both the digital signature and the original document information to the verification server. The verification server may return a successful verification message after both the digital signature and the verification information are verified. The document verification terminal may determine that the two-dimensional code document is authentic after the successful verification message is received from the verification server. In this step, the verification includes the document contents carried in the original document information, a link address or the combination thereof.

In another scenario according to example embodiments of the present disclosure, when the two-dimensional code document to be generated by the two-dimensional code document generating terminal is an exchange voucher, the two-dimensional code document generating terminal may obtain name of the goods, amount of the goods, name of the seller and a deadline of exchanging for the goods, and put the above information as original document information, so as to generate a two-dimensional code document with the original two-dimensional code document generating terminal and a digital signature signed for it included, which is provided to the customer as an exchange voucher. When the customer wishes to exchange for the goods, this exchange voucher will be shown to the seller, and then be verified. If this exchange voucher is determined to be authentic, and the deadline of exchanging for the goods is not yet to come, the seller will supply the corresponding goods to the customer and change the status of the exchange voucher as cancel after verification.

In another scene according to example embodiments, when a two-dimensional code document to be generated by the two-dimensional code document generating terminal is a coupon. At this time, the two-dimensional code document generating terminal may obtain a coupon number, discount rate of the coupon, deadline for using, and applicable goods of the coupon, etc., and put them as original document information, so as to generate a two-dimensional code document with the original two-dimensional code document generating terminal and a digital signature, which is provided to the customer as a coupon. When the customer wishes to request a discount, this coupon will be shown to the seller, and then be verified. If this coupon is determined to be authentic and not yet expires, the seller will offer a corresponding discount. Commonly, a coupon is lapsed after used. Thus the seller will change the status of the coupon as cancelled after verification, which is not explained in detail here.

In another scene according to example embodiments, when a two-dimensional code document to be generated by the two-dimensional code document generating terminal is a cash voucher. At this time, the two-dimensional code document generating terminal may obtain the No. of the cash voucher, applicable mall of the cash voucher, par value of the cash voucher, and, deadline for using, etc., and put them as original document information, so as to generate a two-dimensional code document with the original two-dimensional code document generating terminal and a digital signature signed for it included, which is provided to the customer as a cash voucher. When the customer wishes to use this cash voucher, this cash voucher will be shown to the seller, and then be verified. If this cash voucher is determined to be authentic, and its deadline is not yet to come, it is allowable. After the cash voucher is used, the rest amount of money will be recorded. The status of the cash voucher will be changed as cancel after verification when the rest amount of money becomes zero, which is not explained in detail here.

It should be noted that, once the status of the two-dimensional code document is changed to be cancel after verification, it is not allowed to use it again to request the seller to offer the twice service. The seller may monitor if this transaction has been finished by checking the status of the two-dimensional code document. Of course, if this two-dimensional code document is set to allow the customer to enjoy services for several times, the document verification terminal may record the times of verification, and the status of the two-dimensional code document may be changed as cancel after verification once the time of verification reaches to the maximum.

By this token, in the method of verifying documents according to the embodiments, the two-dimensional code document generating terminal generates a two-dimensional code document with original document information and a digital signature, so that the document verifying terminal performs a verification according to the original document information and the digital signature, and determines the two-dimensional code document to be authentic if the verification is successful. Since both the original document information and the digital signature are included in the two-dimensional code document, it is convenient and accurate to verify the document by verifying the digital signature, which reduces difficulty of verification. Furthermore, due to the digital signature could not be forged and fabricated, thus the forgery issue in the prior art is prevented. In addition, the two-dimensional code documents also avoid the usage of plenty of papery documents which may be lost easily.

In the present embodiment, before verifying the two-dimensional code document according to the original document information and the digital signature, it further includes detecting if the document verification terminal has connected with the verification server, if no, then performing the steps mentioned above to carry out an off-line verification; if yes, then sending a verification message to the verification server to carry out an on-line verification.

In addition, the seller may change the status of the two-dimensional code document as cancelled after verification once the corresponding server has been offered; thereby the transaction process can be monitored.

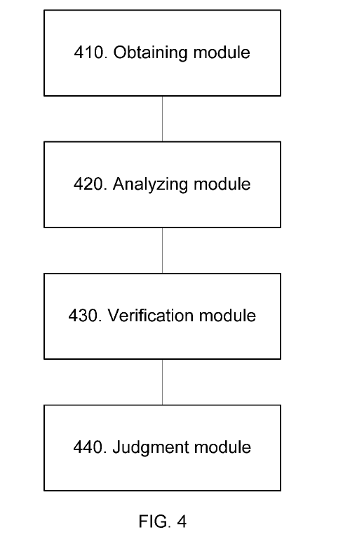

FIG. 4 is a block diagram of a device of verifying documents according to an example embodiment of the present disclosure. The device may be achieved by software, hardware, or the combination of the both, to form a part of or the whole of the document verification terminal. For example, the device may be terminal 800. Further, the device includes an obtaining module 410, an analyzing module 420, a verification module 430, and a judgment module 440.

The obtaining module 410 is configured to obtain a two-dimensional code document to be verified.

The analyzing module 420 is configured to analyze the two-dimensional code document to obtain the original document information and a digital signature signed for the original document information, the digital signature is configured to verify authenticity of the two-dimensional code document.

The verification module 430 is configured to verify the two-dimensional code document according to the original document information and the digital signature.

The judgment module 440 is configured to determine the two-dimensional code document to be authentic if the verification is successful.

By this token, the device of the present disclosure obtains a two-dimensional code document to be verified, then analyzing the two-dimensional code document to get an original document information and a digital signature signed for the original document information, and then verifying the two-dimensional code document according to the original document information and the digital signature; if the verification is successful, the original document is determined to be an authentic document. Since both the original document information and the digital signature are included in the two-dimensional code document, thus it is convenient and accurate to verify the document by verifying the digital signature, which reduces difficulty of verification. Furthermore, due to the digital signature could not be forged and fabricated, thus the forgery issue in the prior art is prevented. In addition, the two-dimensional code documents also avoid the usage of plenty of papery documents which may be lost easily.

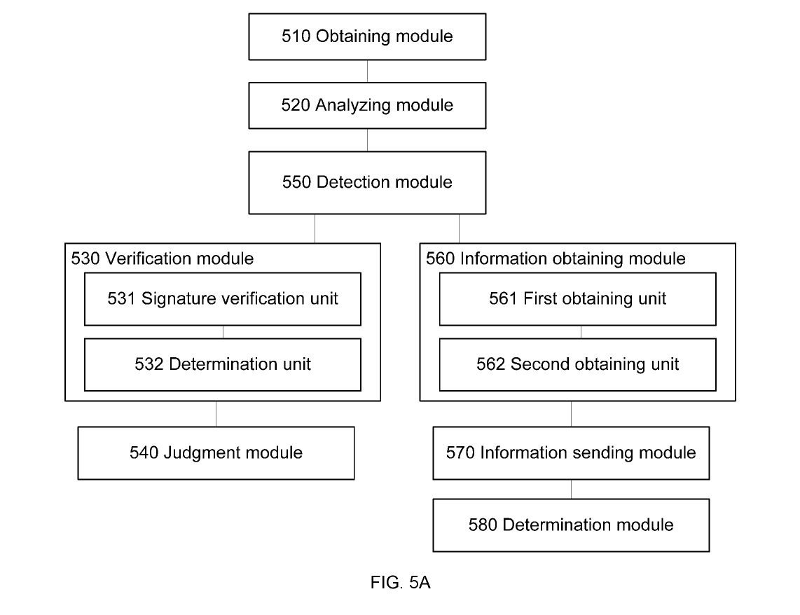

FIG. 5A is a block diagram of a device of verifying documents according to another example embodiment of the present disclosure. The device may be achieved by software, hardware, or the combination of the both, to form a part of or the whole of the document verification terminal. For example, the device may be terminal 800. Further, the device includes an obtaining module 510, an analyzing module 520, a verification module 530, and a judgment module 540.

The obtaining module 510 is configured to obtain a two-dimensional code document to be verified.

The analyzing module 520 is configured to analyze the two-dimensional code document to get original document information and a digital signature signed for the original document information, the digital signature used for verifying authenticity of the two-dimensional code document.

The verification module 530 is configured to verify the two-dimensional code document according to the original document information and the digital signature.

The judgment module 540 is configured to determine the two-dimensional code document to be authentic if the verification is successful.

The device may further include a detection module 550 configured to detect if a verification server has been connected.

And the verification module 530 is further configured to perform the step of verifying the two-dimensional code document according to the original document information and the digital signature, if the verification server is failed to connect.

Additionally, the verification module 530 may include: a signature verification unit 531, configured to verify the digital signature according to the original document information; and a determination unit 532, configured to determine the verification of the two-dimensional code document to be successful, if the verification of the digital signature is successful.

FIG. 5B is a block diagram of the signature verification unit 531 according to an example embodiment of the present disclosure. The signature verification unit 531 includes: a signature decryption subunit 531a, configured to decrypt the digital signature to get a summary report; a plaintext creation subunit 531b, configured to generate a summary report corresponding to the original document information; a signature detection subunit 531c, configured to detect if the summary report which is decrypted matches the summary report which is generated; a determination subunit 531d, configured to determine the verification of the digital signature to be successful when the summary report which is decrypted matches the summary report which is generated.

The device in FIG. 5A further includes:

an information obtaining module 560, configured to obtain a verification message according to the original document information if the verification server has been connected, the verification message including document contents carried in the original document information and/or a link address;

an information sending module 570, configured to send the verification message to the verification server, so as to detect if information matching with the verification message exists, if yes, then returning a successful verification message;

a determination module 580, configured to determine the two-dimensional code document to be authentic after receiving the successful verification message sent by the verification server.

The information obtaining module 560 includes:

a first obtaining unit 561, configured to take the document contents as the verification message if the document contents are included in the original document information; and

a second obtaining unit 562, configured to take the link address as the verification message if the link address of the document contents is included in the original document information; or, send a request for obtaining the document contents to a storage server according to the link address, then receive the document contents returned by the storage server, and take the former or both of the document contents and the link address as the verification message.

As another embodiment, if the two-dimensional code document is a receipt document, then the document contents include receipt date, receipt reason, payee information, payer information and amount of money;

if the two-dimensional code document is a payment document, then the document contents include payment date, payment reason, payee information, payer information and payment amount;

if the two-dimensional code document is a transfer document, then the document contents include transfer date, transferor information, transferee information, transfer amount and transfer organization information;

if the two-dimensional code document is a delivery receipt, then the document contents include delivery date, name of goods, deliverer information, receipt side information and amount of goods;

if the two-dimensional code document is a goods-pick-up document, then the document contents include deadline for receiving goods, name of goods, receiver information and amount of goods;

if the two-dimensional code document is a goods-transfer document, then the document contents include transfer date, transferor information, receiver information and amount of goods.

In conclusion, the device of verifying documents in the present embodiment obtains a two-dimensional code document to be verified, and then analyzes the two-dimensional code document to get an original document information and a digital signature signed for the original document information, and then verifies the two-dimensional code document according to the original document information and the digital signature, if the verification is successful, the original document is determined to be authentic. Since both the original document information and the digital signature are included in the two-dimensional code document, it is convenient and accurate to verify the document by verifying the digital signature, which reduces difficulty of verification. Furthermore, due to the digital signature could not be forged and fabricated, thus the forgery issue in the prior art is prevented. In addition, the two-dimensional code documents also avoid the usage of plenty of papery documents which may be lost easily.

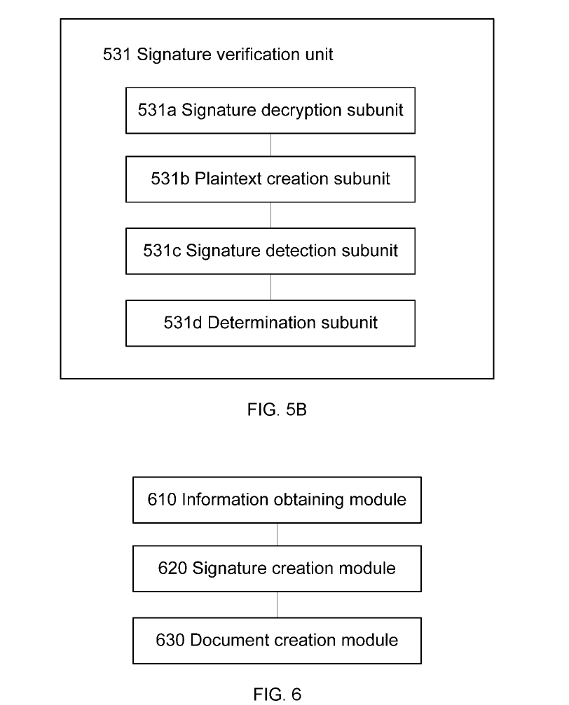

FIG. 6 is a block diagram of a device of generating documents according to an example embodiment of the present disclosure. The device may be achieved by software, hardware, or the combination of the both, to form a part of or the whole of the document verification terminal. For example, the device may be the terminal 800. Further, the device may include an information obtaining module 610, a signature creation module 620, and document creation module 630.

In this step, the information obtaining module 610 is configured to obtain original document information.

The signature creation module 620 is configured to generate a digital signature of the original document information according to a digital signature algorithm.

The document creation module 630 is configured to generate a two-dimensional code document including the original document information and the digital signature, and the digital signature i authenticity of the two-dimensional code document.

In conclusion, the device of generating documents in the present embodiment obtains original document information, and generates a digital signature of the original document information, and finally generates a two-dimensional code document with the original document information and the digital signature. Due to the digital signature could not be forged and fabricated, thus the forgery issue in the prior art is prevented. Furthermore, since both the original document information and the digital signature are included in the two-dimensional code document, thus it is convenient and accurate to verify the document by verifying the digital signature, which reduces difficulty of verification. In addition, the two-dimensional code documents also avoid the usage of plenty of papery documents which may be lost easily.

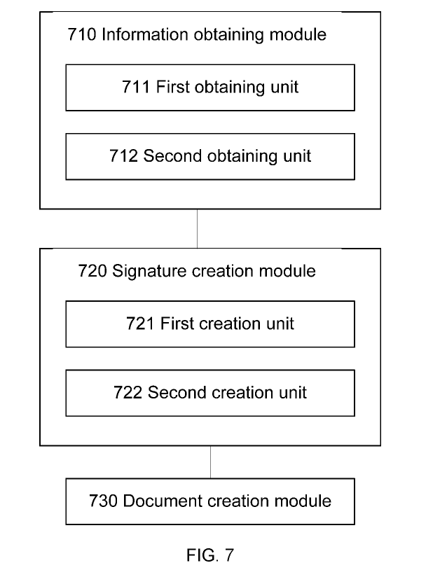

FIG. 7 is a block diagram of a device of generating documents according to another example embodiment of the present disclosure. The device may be achieved by software, hardware, or the combination of the both, to form a part of or the whole of the document verification terminal. For example, the device may be the terminal 800. Further, the device may include an information obtaining module 710, a signature creation module 720, and document creation module 730.

The information obtaining module 710 is configured to obtain original document information.

The signature creation module 720 is configured to generate a digital signature of the original document information according a digital signature algorithm.

The document creation module 730 is configured to generating a two-dimensional code document with the original document information and the digital signature included, and the digital signature is configured to verify authenticity of the two-dimensional code document.

As an embodiment, when the document verification terminal needs to verify authenticity of the two-dimensional code document, and the document verification terminal fails to connect with a verification server, the original document information and the digital signature are configured to instruct the document verification terminal to verify the digital signature according to the original document information, and the two-dimensional code document is determined to be authentic if the verification of the digital signature is successful.

When the document verification terminal needs to verify authenticity of the two-dimensional code document, and the document verification terminal is connected with a verification server, the original document information is configured to instruct the verification server to detect if information matching with verification message exists, if yes, the two-dimensional code document is determined to be authentic, wherein the verification message includes document contents carried in the original document information and/or a link address.

The information obtaining module 710 includes a first obtaining unit 711 configured to obtain document contents and then taking them as the original document information; or a second obtaining unit 712 configured to obtain a link address of the document contents, and then take it as the original document information.

If the two-dimensional code document is a receipt document, the document contents include receipt date, receipt reason, payee information, payer information and amount of money;

if the two-dimensional code document is a payment document, the document contents include payment date, payment reason, payee information, payer information and payment amount;

if the two-dimensional code document is a transfer document, the document contents include transfer date, transferor information, transferee information, transfer amount and transfer organization information;

if the two-dimensional code document is a delivery receipt, the document contents include delivery date, name of goods, deliverer information, receipt side information and amount of goods;

if the two-dimensional code document is a goods-pick-up document, the document contents include deadline for receiving goods, name of goods, receiver information and amount of goods;

if the two-dimensional code document is a goods-transfer document, the document contents include transfer date, transferor information, receiver information and amount of goods.

The signature creation module 720 includes:

a first creation unit 721 configured to generate a summary report of the original document information according to the digital signature algorithm and the original document information;

a second creation unit 722 configured to encrypt the summary report to get the digital signature.

In conclusion, the device of generating documents in the present embodiment obtains original document information, and generates a digital signature of the original document information, and finally generates a two-dimensional code document with the original document information and the digital signature. Due to the digital signature could not be forged and fabricated, thus the forgery issue in the prior art is prevented. Furthermore, since both the original document information and the digital signature are included in the two-dimensional code document, thus it is convenient and accurate to verify the document by verifying the digital signature, which reduces difficulty of verification. In addition, the two-dimensional code documents also avoid the usage of plenty of papery documents which may be lost easily.

It should be noted that, the document verification terminal and the two-dimensional code document generating terminal could form a system of verifying documents. In this step, the document verification terminal can be the device shown in FIG. 4 or FIG. 5A, and the two-dimensional code document generating terminal can be the device shown in FIG. 6 or FIG. 7. Detailed description can be reviewed in the embodiments relevant to the methods, which is not repeated here.

It should be noticed that, functions of device of generating documents and device of verifying documents are explained as an example by dividing them into several functional modules. But in the actual application, different functional modules could be included so as to perform the functions. That is the structure of the device can be divided into different functional modules, to perform a part of or the whole of functions mentioned above. In addition, the embodiments of the devices and the embodiments of the methods pertain to the same concept, which are not repeated here.

And the number of the embodiments is used merely for better description.

Apparently, persons skilled in the art could understand that part of or whole of the steps in the embodiments can be achieved by hardware or programs by instructing the hardware. Such programs can be stored in storage device to be performed by the computer device, such as read-only memory, disk or compact disk, etc.

Thus, example embodiments illustrated in FIGS. 1-8 serve only as examples to illustrate several ways of implementation of the present disclosure. They should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

What is claimed is:

1. A terminal for verifying the authenticity of a document, comprising:
a processor-readable storage medium comprising a set of instructions for verifying a document; and
a processor in communication with the storage medium configured to execute the set of instructions to:
obtain a two-dimensional code encrypted from an original document that comprises original document information and a digital signature that includes a first summary report corresponding to the original document information;
retrieve from the two-dimensional code the original document information and the digital signature;
verify the two-dimensional code according to the original document information and the digital signature; and
determine the two-dimensional code to be authentic when the verification is successful.

2. The verifying terminal device according to claim 1, wherein to verify the two-dimensional code the processor is further configured to execute the set of instructions to:
decrypt the digital signature to obtain the first summary report;
generate a second summary report corresponding to the original document information; and
determine the verification of the two-dimensional code to be successful when the first summary report matches the second summary report.

3. The verifying terminal device according to claim 1, wherein to verify the two-dimensional code the processor is further configured to execute the set of instructions to:
obtain a verification message according to the original document information;
send the verification message to a verification server; and
determine the verification of the two-dimensional code to be successful when receiving a successful verification message from the verification server that information saved therein matches the verification message.

4. The verifying terminal device according to claim 3, wherein the verification message comprises at least one of document content of the original document and a link address associated with the original document.

5. The verifying terminal device according to claim 4, wherein when the original document information comprises the link address, the processor is further configured to execute the set of instructions to:
send a request for obtaining the document content to a server according to the link address;
receive the document content from server, and take the document content or both of the document content and the link address as the verification message.

6. The verifying terminal device according to claim 4, wherein:
when the two-dimensional code is a receipt document associated with a transaction between payer and payee, the document content comprises a receipt date, a receipt reason, information of the payee, information of the payer, and an amount of money in the transaction;
when the two-dimensional code is a payment document of a transaction between payer and payee, the document content comprises a payment date, a payment reason, information of the payee, information of the payer, and a payment amount of the transaction;
when the two-dimensional code is a transfer document of a transfer between a transferor and a transferee, the document content comprises a transfer date, information of the transferor, information of the transferee, a transfer amount, and information of a transfer organization associated with the transfer;
when the two-dimensional code is a delivery receipt associated with a transaction between a deliverer and a recipient, the document content comprises a delivery date, a name of goods to be delivered, information of the deliverer, information of the recipient, and an amount of the goods to be delivered;
when the two-dimensional code is a goods-pick-up document associated with a transaction, the document content comprises a deadline for receiving goods, a name of goods to be picked up, information of a receiver, and an amount of the goods to be picked up; and
when the two-dimensional code is a goods-transfer document associated with a transaction between a transferor and a recipient, the document content comprises a transfer date, information of the transferor, information of the recipient, and an amount of goods to be transferred.

7. A method for verifying a document by a verifying terminal, comprising:
obtaining, by the verifying terminal, a two-dimensional code encrypted from an original document that comprises original document information and a digital signature comprising a first summary report corresponding to the original document information;
retrieving from the two-dimensional code the original document information and the digital signature;
verifying the two-dimensional code according to the original document information and the digital signature; and
determining the two-dimensional code to be authentic when the verification is successful.

8. The method according to claim 7, wherein the verifying of the two-dimensional code comprises:
decrypting the digital signature to obtain the first summary report;
generating a second summary report corresponding to the original document information; and
determining the verification of the two-dimensional code to be successful when the first summary report matches the second summary report.

9. The method according to claim 7, wherein the verifying of the two-dimensional code comprises:
obtaining a verification message according to the original document information;
sending the verification message to a verification server; and
determining the verification of the two-dimensional code to be successful when receiving a successful verification message from the verification server that information saved therein matches the verification message.

10. The method according to claim 9, wherein the verification message comprises at least one of document content of the original document and a link address associated with the original document.

11. The method according to claim 10, wherein when the original document information comprises the link address, the obtaining of the verification message comprises:
sending a request for obtaining the document content to a server according to the link address;
receiving the document content from server; and
taking the document content or both of the document content and the link address as the verification message.

12. The method according to claim 10, wherein:
when the two-dimensional code is a receipt document associated with a transaction between payer and payee, the document content comprises a receipt date, a receipt reason, information of the payee, information of the payer, and an amount of money in the transaction;
when the two-dimensional code is a payment document of a transaction between payer and payee, the document content comprises a payment date, a payment reason, information of the payee, information of the payer, and a payment amount of the transaction;
when the two-dimensional code is a transfer document of a transfer between a transferor and a transferee, the document content comprises a transfer date, information of the transferor, information of the transferee, a transfer amount, and information of a transfer organization associated with the transfer;
when the two-dimensional code is a delivery receipt associated with a transaction between a deliverer and a recipient, the document content comprises a delivery date, a name of goods to be delivered, information of the deliverer, information of the recipient, and an amount of the goods to be delivered;
when the two-dimensional code is a goods-pick-up document associated with a transaction, the document content comprises a deadline for receiving goods, a name of goods to be picked up, information of a receiver, and an amount of the goods to be picked up; and
when the two-dimensional code is a goods-transfer document associated with a transaction between a transferor and a recipient, the document content comprises a transfer date, information of the transferor, information of the recipient, and an amount of goods to be transferred.

13. A terminal, comprising:
a processor-readable storage medium comprising a set of instructions for generating a two-dimensional code by the terminal; and
a processor in communication with the storage medium configured to execute the set of instructions to:
obtain original document information comprised in an original document information;
generate a first summary report based on the original document information;
encrypt the first summary report into a digital signature of the original document information; and
generate a two-dimensional code based on the original document information and the digital signature.

14. The terminal according to claim 13, wherein to generate the two-dimensional code the processor is further configured to execute the set of instructions to encrypt a link address of the original document and the digital signature into the two-dimensional code.

15. The terminal according to claim 13, wherein to generate the two-dimensional code the processor is further configured to execute the set of instructions to encrypt document content of the original document and the digital signature into the two-dimensional code.

16. The terminal according to claim 13, wherein:
when the two-dimensional code is a receipt document associated with a transaction between payer and payee, the original document comprises a receipt date, a receipt reason, information of the payee, information of the payer, and an amount of money in the transaction;
when the two-dimensional code is a payment document of a transaction between payer and payee, the original document comprises a payment date, a payment reason, information of the payee, information of the payer, and a payment amount of the transaction;
when the two-dimensional code is a transfer document of a transfer between a transferor and a transferee, the original document comprises a transfer date, information of the transferor, information of the transferee, a transfer amount, and information of a transfer organization associated with the transfer;
when the two-dimensional code is a delivery receipt associated with a transaction between a deliverer and a recipient, the original document comprises a delivery date, a name of goods to be delivered, information of the deliverer, information of the recipient, and an amount of the goods to be delivered;
when the two-dimensional code is a goods-pick-up document associated with a transaction, the original document comprises a deadline for receiving goods, a name of goods to be picked up, information of a receiver, and an amount of the goods to be picked up; and
when the two-dimensional code is a goods-transfer document associated with a transaction between a transferor and a recipient, the original document comprises a transfer date, information of the transferor, information of the recipient, and an amount of goods to be transferred.

17. A method for generating a two-dimensional code by a terminal, comprising:
obtaining, by the terminal, original document information comprised in an original document information;
generating a first summary report based on the original document information;
encrypting the first summary report into a digital signature of the original document information; and
generating a two-dimensional code based on the original document information and the digital signature.

18. The method according to claim 17, wherein the generating of the two-dimensional code comprising encrypting a link address of the original document and the digital signature into the two-dimensional code.

19. The method according to claim 17, wherein the generating of the two-dimensional code comprising encrypting document content of the original document and the digital signature into the two-dimensional code.

20. The method according to claim 17, wherein:
when the two-dimensional code is a receipt document associated with a transaction between payer and payee, the original document comprises a receipt date, a receipt reason, information of the payee, information of the payer, and an amount of money in the transaction;
when the two-dimensional code is a payment document of a transaction between payer and payee, the original document comprises a payment date, a payment reason, information of the payee, information of the payer, and a payment amount of the transaction;
when the two-dimensional code is a transfer document of a transfer between a transferor and a transferee, the original document comprises a transfer date, information of the transferor, information of the transferee, a transfer amount, and information of a transfer organization associated with the transfer;
when the two-dimensional code is a delivery receipt associated with a transaction between a deliverer and a recipient, the original document comprises a delivery date, a name of goods to be delivered, information of the deliverer, information of the recipient, and an amount of the goods to be delivered;
when the two-dimensional code is a goods-pick-up document associated with a transaction, the original document comprises a deadline for receiving goods, a name of goods to be picked up, information of a receiver, and an amount of the goods to be picked up; and
when the two-dimensional code is a goods-transfer document associated with a transaction between a transferor and a recipient, the original document comprises a transfer date, information of the transferor, information of the recipient, and an amount of goods to be transferred.
